(19) United States
(12) Patent Application Publication
(10) Pub. No.: US 2008/0318008 A1
(43) Pub. Date: Dec. 25, 2008

(54) Method and Apparatus for Application of a Pattern, Element and Device Provided with Such a Pattern

(75) Inventors: Ytsen Wielstra, Drachten (NL); Jolanda Harma Sagitta Van De Woudewinkel, Drachten (NL); Gerrit Jan De Jong, Drachten (NL); Rien Vugts, Drachten (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS, NV, EINDHOVEN (NL)

(21) Appl. No.: 11/574,659

(22) PCT Filed: Aug. 30, 2005
(86) PCT No.: PCT/IB2005/052828

§ 371 Date: Mar. 2, 2007

(30) Foreign Application Priority Data
Sep. 3, 2004 (EP) 04104244.1

(51) Int. Cl. B32B 3/00; B05D 3/06; B05C 11/02

(52) U.S. Cl. 428/195.1; 427/555; 118/695

(57) ABSTRACT

The invention relates to a method and apparatus for application of a decorative pattern to a substrate coated with a coating layer, an element comprising a surface coated with a coating layer with such a pattern, as well as a device provided with such an element. The method employs laser ablation of the pattern in a coating layer, followed by the application of ink in the laser-ablated pattern. The method according to the invention is more flexible with respect to the nature of the coating than known methods.

The invention relates to a method and apparatus for application of a pattern to a substrate coated with a coating layer. The invention further relates to an element comprising a surface coated with a coating layer with such a pattern. The invention also relates to a device provided with such an element.

Many devices, such as electrical devices, audio and video equipment, have decorative or informative patterns. For instance, buttons of a device may be provided with information concerning the function of that button, and decorative patterns such as a manufacturer logo may also be applied.

The application of decorative or informative patterns on substrates is commonly performed by pad printing techniques. However, the pad printing technique is rather inflexible as the obtainable quality and resolution of the print is highly dependent on the nature of the surface to which the pattern is applied.

A higher flexibility may be obtained by ink jet printing. However, the resolution obtainable by the ink jet printing technique is also limited by the nature of substrate. For high-resolution printing the substrate should have suitable ink absorbing properties. This makes the ink jet printing techniques rather inflexible. Many types of substrate do not have suitable absorption properties, causing unwanted flow of applied ink over the surface, causing a blurred pattern with a relatively low resolution as a result. Thus, these printing techniques can not be applied at high resolution on certain unsuitable substrates, in particular coatings such as colored lacquers and plastic or metallic finishes.

Another disadvantage of known printing techniques is that the printed pattern has a rather poor mechanical resistance. For instance, the information printed on a certain button of a device that is often used, tends to wear off the surface of the button.

The invention aims to provide a method for application of a durable pattern to a surface coated with a coating layer at a relatively high resolution that is more flexible with respect to the nature of the coating than known methods.

The invention provides a method for application of a pattern to a substrate coated with a coating layer, comprising the following steps: A) laser ablation of the pattern in the coating layer, and B) application of ink in the laser-ablated pattern. The laser ablation provides high-resolution patterns that contain the ink, thus preventing the flowing of the ink and maintaining the high resolution independent of the nature of the coating layers. Thus, due to the method according to the invention it is now possible to obtain high-resolution patterns even on coatings that would cause flowing and blurring of the ink. Fine details ablated by laser may even absorb ink by capillary force. Further, while the ink of the pattern is embedded in the coating layer, the pattern is less sensitive to wear compared to patterns printed on top of the coating layer. Also, the ink is less accessible to chemicals, thus further improving the durability compared to the usual printed patterns.

It is preferred if the laser ablation is restricted to a fraction of the coating layer located at the surface of the coating layer remote from the substrate. Thus, the substrate remains completely coated by the coating layer and the ink does not contact the substrate. Thus, the substrate remains protected from environmental influences by the coating layer during the method. It is especially preferred if the laser-ablated fraction of the coating layer comprises a top layer of a multi-layered coating layer. In the multi-layered coating layer, the top layer may be chosen to have especially suitable characteristics for laser ablation, yielding a superior quality pattern.

It is preferred if the coating layer comprises a sol-gel coating. Laser ablation of sol-gel coatings yields exceptionally sharply cut patterns, enabling a high resolution. Silane-based materials that lack a melting point form the main component of sol-gel coatings. Coating layers with meltable coatings usually suffer somewhat in terms of resolution, due to partial melting of melting of coating material at the contours of the pattern. The lack of melting point for sol-gel coatings results in sharply cut laser-ablated patterns, enabling an optimal graphic resolution.

In a preferred embodiment of the invention, the ink comprises an irradiation-curable component, and the method also comprises the following step: C) irradiation of the ink material after application. The use of irradiation enables controlled fixation of the ink in the pattern. The irradiation may be any kind of suitable irradiation, dependent on the irradiation-curable component in the ink. The irradiation may for instance comprise infrared light, causing heat-curable ink to harden. It is preferred if the ink comprises a UV-curable component, and the irradiation comprises the use of UV-light. UV stand for ultra-violet irradiation, and enables rapid curing of suitable components. Many convenient UV-curable components are suitable.

It is preferred if in step B) the ink material is applied in the ablated pattern by a micro drop method. Micro drop methods enable the precise dispensing of ink into exact positions of the pattern. It is particularly preferred if the micro drop method comprises an ink jet method. Ink jet methods are suitable to apply ink in precise, tiny amounts, at a rapid rate.

In a preferred embodiment of the invention, the steps of the method are driven by a common controlling device. The common controlling device, typically comprising a microprocessor, enables automation of the method, allowing for a controlled process carried out at a high rate.

The invention further provides an apparatus for performing the method according to any the invention, characterized in that the apparatus comprises laser means for ablation of a pattern in a coating layer of a substrate, applicator means for applying ink in the ablated pattern, positioning means for positioning the substrate, and a controlling device for driving the laser means and the applicator means. Such an apparatus is suitable for application of a decorative pattern to a surface coated with a coating layer at a relatively high resolution that is more flexible with respect to the nature of the coating than known methods. The apparatus enables the application of such a pattern in an automated manner, offering the advances of rapid production in a controlled way. The apparatus may be a stand-alone device, but may as well be integrated in a production line. The apparatus may also comprise means for other production steps, such as means for application of a coating to a substrate.

It is preferred if the controlling device also drives the positioning means. Optimal co-operation with the laser means and the applicator means enables higher production speeds.

In a preferred embodiment, the apparatus also comprises irradiation means. This enables the use of radiation-curable inks for filling the pattern, for relatively rapid fixation of the ink within the pattern. The irradiation means may for instance comprise a lamp or a laser (typically operating at lower power than the cutting laser employed for the laser ablation step. Preferably, the irradiation means comprise UV-light means. UV-light allow for the rapid curing of UV-curable inks. The UV-means may for instance comprise a UV lamp or a low-powered UV-laser.

It is preferred if the applicator means comprise a micro drop head. A micro drop head is capable of delivering precise small amounts of ink to the ablated pattern. Further, it is possible to position the micro drop head with high precision, minimizing spills of ink. It is especially preferred if the micro drop head is an ink jet head. Ink jet heads deliver very small amounts of ink, allowing for greater precision. Besides, ink jet heads allow for operation at high ink application rates.

The invention further provides an element comprising a surface coated with a coating layer with a pattern, obtained by the method according to the invention. Such a decorated element is provided of a pattern that has a high durability, while the ink is embedded in the coating, and therefore less susceptible towards chemical and mechanical wear. Also, the resolution of the obtained pattern may be relatively high. Moreover, the use of the method according to the invention enables a greater flexibility in the choice of the coating layer.

In a preferred embodiment the pattern is embedded in a fraction of the coating layer located at the surface of the coating layer remote from the substrate. The substrate remains completely coated by the coating layer and the ink does not contact the substrate. It is especially preferred if the laser-ablated fraction of the coating layer comprises a top layer of a multi-layered coating layer. In the multi-layered coating layer, the top layer may be chosen to have especially suitable characteristics for laser ablation, yielding a superior quality pattern.

Preferably, the coating layer comprises a sol-gel coating. Laser ablation of sol-gel coatings results in very sharply cut patterns at high resolution, allowing for very fine details in the pattern, not achievable with most other coatings. In a multi-layered coating layer, wherein several material layers are stacked to form the coating layer, preferably at least the top layer is a sol gel coating layer, which results in the optimal visual appearance.

The invention also provides a device comprising at least one element comprising a surface coated with a coating layer with a pattern, obtained by the method according to the invention. Thus, the pattern on that element has a high durability, increased chemical and mechanical wear-resistance, while a relatively high resolution is achievable. The patterns may be in particular employed for elements used at devices that operate under repeated mechanical and/or chemical strain, for instance buttons that are repeatedly pushed for operation of the device.

In a preferred embodiment, the device is an electrical shaver. For instance, the shaving unit of an electrical shaver may be provided with a coating and a decorative pattern applied with the method according to the invention. The shaving unit endures plenty of mechanical and chemical strain during shaving (with or without the aid of shaving additives, in particular corrosive ingredients of pre- and after-shave tonics, foams and oils). However, the applied pattern is preserved due to its improved durability compared to for instance patterns printed on top of the coating using conventional printing techniques.

The invention will now be further explained by the following examples.

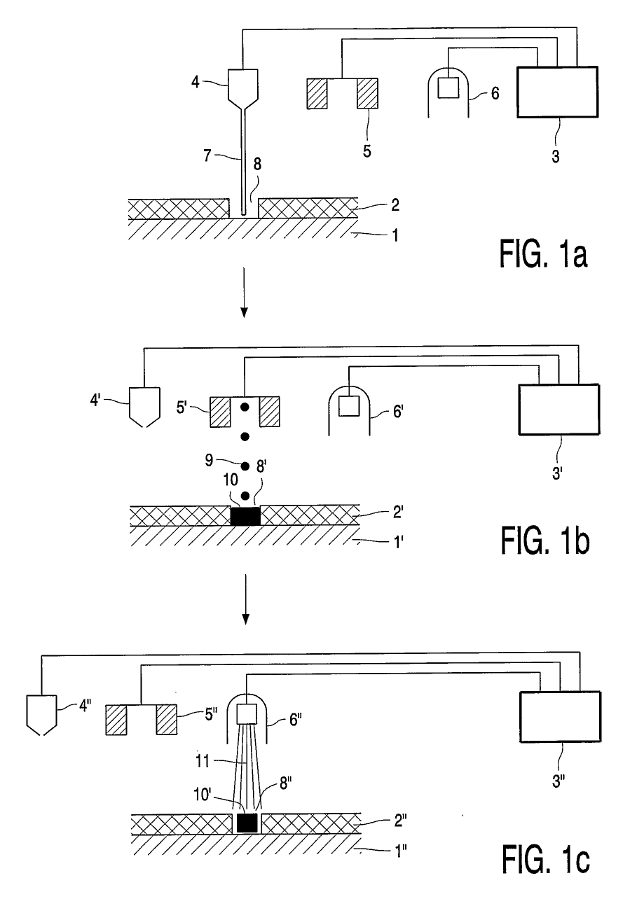

FIGS. 1a-c shows a schematic overview of the method according to the invention.

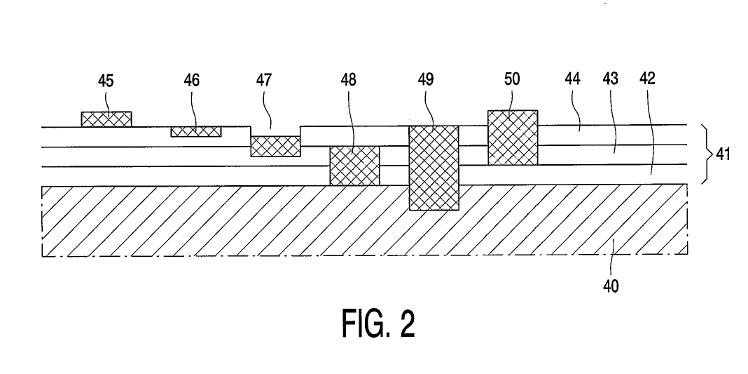

FIG. 2 shows various patterns applied to a substrate with a multi-layered coating.

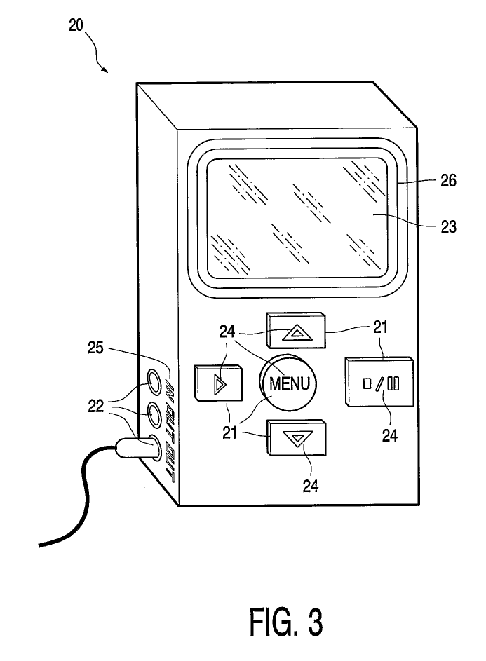

FIG. 3 shows a device provided with elements with patterns applied to them according to the method of the invention.

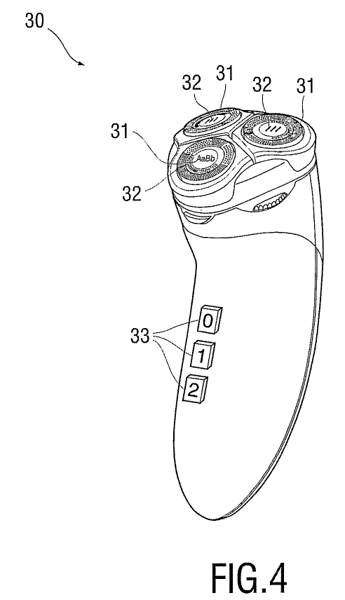

FIG. 4 shows another device provided with elements with patterns applied to them according to the method of the invention.

FIG. 1 a shows a laser ablation step of the method according to the invention. The figure shows a substrate 1 coated with a coating layer 2. A pattern is applied according to the invention by an apparatus comprising a controller unit 3 that operates a cutting laser 4, an ink jet head 5, and a UV-light source 6. Also, the common controller unit positions the substrate 1 with respect to the cutting laser 4, ink jet head 5, and UV-light source 6, by positioning means (not shown in the figure), such as a conveyor belt, adjustable clamp, or a robotic arm. These positioning means allow for application of a pattern on any part of the surface of the substrate. In this figure, the laser beam 7 generated by the cutting laser 4 applies a pattern in the coated surface by laser ablation of at least part of the coating layer 2, resulting in a gap 8. In this non-limiting example, the gap extends from the top surface of the coating layer 2 to the top surface of the substrate 1. It is however possible to ablate a less deep gap 8, extending only over part of the thickness of the coating layer 2. Thus, the substrate 1 will remain completely coated, resulting in sustained protection of the substrate 1 against environmental hazards. On the other hand, it is also possible to extend the gap 8 created by laser ablation beyond the coating layer 2 and into the substrate 1, resulting in deeper pattern with improved durability.

FIG. 1b shows the application of ink in the laser-ablated pattern. Numbers correspond with the numbers in FIG. 1a. Now, the ink jet head 5′ has been precisely positioned, guided by the controller unit 3′, over the laser-ablated gap 8′. The gap 8′ is filled by micro droplets 9 of UV-curable ink applied by the ink jet head 5′. The liquid filling ink 10 is applied up to the level of the upper surface of the coating layer 2′, in order to obtain a smooth surface.

FIG. 1c shows the curing of the UV-radiation-curable ink. Numbers correspond with the numbers in figures la and lb. The controller unit 3″ has guided the UV-light source 6 over the laser-ablated gap 8″ that is filled with UV-curable ink 10″. The UV-radiation cures the UV-curable ink rapidly and precisely. The controller 3″ may operate the cutting laser 4″, ink jet head 5″, and UV-light source 6″simultaneously on different areas of the substrate 1″ in order to obtain a rapid process. Also, the number of slower operating units may be a multiple of the number of the fastest operating units, in order to optimize the production speed of the process. For instance, an apparatus that performs the method according to the invention may comprise one laser, that is capable of performing the laser ablation step very rapidly, and multiple, for instance three, ink jet heads, that perform the application of ink in the ablated pattern relatively slowly.

FIG. 2 shows various patterns applied to a substrate 40 with a multi-layered coating 41. The multi-layered coating 41 comprises three stacked coating layers: a ground layer 42 applied to the substrate 40, an intermediate layer 43 applied to the surface of the ground layer 42, and a top layer 44 covering the intermediate layer 43. These layers 42, 43, 44 have been applied to the substrate 40 in separate coating steps. For this example an arbitrary three-layered coating 41 was chosen, but those skilled in the art will appreciate that the examples may be varied and used on any coating, such as one-layered coatings, two-layered coatings or coatings with more than three layers. Several types of patterns applied to the stacked coating layers 41 are shown. The first pattern 45 is applied by a conventional method, by simply printing ink on top of the top coating layer 44. This first pattern is rather prone to wear. The second pattern 46 is applied according to the invention, by laser ablation of a fraction of the thickness of the top coating layer 44, followed by application of the ink to fill the laser-ablated gap. Compared to the first pattern 45, this second pattern 46 has an improved durability. The third pattern 47 shows a gap that was laser-ablated into multiple layers (the top layer 44 and part of the intermediate layer 43), after which the gap was only partially filled with ink. Thus, the ink surface lays below the surface of the top layer 44, resulting in an improved durability and an aesthetically attractive effect. A fourth pattern 48 lays below the top layer 44. This was accomplished by laser-ablating the intermediate coating layer 43 and the ground coating layer 42 and filling the laser-ablated gap with ink before the top coating layer 44 was applied. Thus, the top coating layer 44 seals the pattern 48, leading to an improved durability. Preferably, the top layer is at least partially translucent in order to make the pattern 48 visible. The fifth pattern 49 is an example of a pattern was laser-ablated through the coating layer 41 and into the substrate 40, resulting in an improved durability of the pattern 49. The last pattern 50 is an example of a pattern that is partially embedded in the coating layers 41, and partially extends over the surface of the top layer 44. This results in an attractive visual effect. Although the part of the pattern that extends from the top coating layer 44 may be prone to wear due to repeated mechanical strain, still the durability of the pattern 50 is maintained as the part of the pattern 50 embedded in the coating layers 41 benefits from the improved durability provided by the method according to the invention.

FIG. 3 shows a portable media-player device 20, for instance a mp3 player, on which various decorative and informative patterns are applied using the method according to the invention. The media player device 20 is provided with several operating buttons 21, in- and out ports 22, and a control screen 23. The operating buttons 21 are susceptible to wear, as they are under repeated strain during operation of the media player device 20. All buttons 21 may be finished in any fashionably colored coating lacquer. The operating buttons 21 are provided with informative signs, indicators and inscriptions, showing their function (for instance the familiar play, stop/pause, and menu scrolling buttons), obtained by applying contrasting ink using the method according to the invention. The result of the method according to the invention are informative signs, indicators and inscriptions, that have a much higher wear-resistance compared to signs that are printed on top of the coating lacquer. The device 20 shown here does not suffer from buttons that have lost their signs due to repeated use of those buttons. Also, due to the use of laser ablation, the resolution of the signs may be significantly higher. Moreover, the types of coating lacquers or other finishes that may be used for the device is very flexible. Other parts of the media player device 20 that are decorated using the method according to the invention are the indications 25 of the in- and out ports 22, and the border 26 of the screen 23.

FIG. 4 shows an electric shaver device 30. Especially the parts contacting the skin of a user during operation are prone to wear, and may also be subjected to the influence of shaving additives such as pre- and after-shaves. The shaving units 31 of the shaver 30 are protected from the repeated mechanical and chemical strain that may occur during shaving by a colored coating layer that extends over all outward surfaces of the shaver 30. Decorative patterns 32, for instance manufacturer logos, are applied to specific parts of the colored coating layer using the method according to the invention. Due to the embedded nature of the patterns in the colored coating layer, the patterns have an improved capability to withstand mechanical and mechanical hazards that would usually lead to wear of the patterns if conventional printed patterns were applied instead. Another advantage of the patterns 32 applied using the method of the invention is that relatively high resolutions are relatively easily obtainable. Other elements of the shaver device 30 that are also prone to wear due to repeated use are the operating buttons 33. Therefore, the indicators on to of the operating buttons 33 are also applied using the method according to the invention.

Those skilled in the art will appreciate the broad scope of the invention, that is obviously not limited by the examples explicitly shown here. For those skilled in the art, numerous variations are possible on the method according to the invention, the apparatus to performing the method, and the application of the method on various elements and devices.

1. Method for application of a pattern to a substrate coated with a coating layer, comprising the following steps:
A) laser ablation of the pattern in the coating layer, and
B) application of ink in the laser-ablated pattern.

2. Method according to claim 1, characterized in that the laser ablation is restricted to a fraction of the coating layer located at the surface of the coating layer remote from the substrate.

3. Method according to claim 1, characterized in that the laser-ablated fraction of the coating layer comprises a top layer of a multi-layered coating layer.

4. Method according to claim 1, characterized in that the coating layer comprises a sol-gel coating.

5. Method according to claim 1, characterized in that the ink comprises an irradiation-curable component, and the method also comprises the following step:
C) irradiation of the ink material after application.

6. Method according to claim 4, characterized in that the ink comprises a UV-curable component, and the irradiation comprises the use of UV-light.

7. Method according to claim 1, characterized in that in step B) the ink material is applied in the ablated pattern by a micro drop method.

8. Method according to claim 7, characterized in that the micro drop method comprises an ink jet method.

9. Method according to claim 1, characterized in that the steps of the method are driven by a common controlling device.

10. Apparatus for performing the method according to claim 1, characterized in that the apparatus comprises:
laser means for ablation of a pattern in a coating layer of a substrate,
applicator means for applying ink in the ablated pattern,
positioning means for positioning the substrate, and
a controlling device for driving the laser means and the applicator means.

11. Apparatus according to claim 10, characterized in that the controlling device also drives the positioning means.

12. Apparatus according to claim 10, characterized in that the apparatus also comprises irradiation means.

13. Apparatus according to claim 12, characterized in that the irradiation means comprise UV-light means.

14. Apparatus according to claim 10, characterized in that the applicator means comprise a micro drop head.

15. Apparatus according to claim 14, characterized in that the micro drop head is an ink jet head.

16. Element comprising a surface coated with a coating layer with a pattern, obtained by the method according to claim 1.

17. Element according to claim 16, characterized in that the pattern is embedded in a fraction of the coating layer located at the surface of the coating layer remote from the substrate.

18. Element according to claim 17, characterized in that the coating layer comprises a sol-gel coating.

19. Device comprising at least one element according to claim 16.

20. Device according to claim 19, characterized in that the device is a an electrical shaver.
